(19) United States
(12) Patent Application Publication
(10) Pub. No.: US 2002/0071241 A1
(43) Pub. Date: Jun. 13, 2002

(54) Weather resistant self-contained surface-mounted 12 volt direct current electrical control unit for small boats

(76) Inventor: William Eugene Lockridge, Mint Hill, NC (US)

Correspondence Address: William Eugene Lockridge, 9537 Goldsmith Lane, Mint Hill, NC, 28227, US

(21) Appl. No.: 09/860,879

(22) Filed: May 17, 2001

Related U.S. Application Data
(60) Provisional application No. 60/205,013, filed on May 17, 2000.

(51) Int. Cl. H02B 1/00

(52) U.S. Cl. 361/601

(57) ABSTRACT

A weather resistant self-contained surface-mounted 12 volt direct current electrical control unit for small boats comprising as the major components; a weather resistant enclosure in two parts (flanged enclosure & cover), a plurality of surface mounted fuse holders, and a plurality of switches together with the necessary screws, gaskets, wire, tie wraps, and connectors to complete the relevant electrical circuits and to secure the component parts. The enclosure is configured to allow the passage, through an opening, of power cables from an external power supply into the device and conversely the passage outwards of individual electrical leads to be connected to the various devices and accessories to be controlled with the invention. The invention is assembled using the weather-resistant surface-mountable electrical enclosure that has a weather resistant cover plate retained in place with screws or other fasteners, and having the switches and fuse holders mounted on the cover plate. Said cover plate is labeled to reflect the applicability of each switch device and related fuse holder. The purpose of the invention is to allow boat owners, dealers, marina operators, manufacturers, and others to quickly, safely, conveniently, and without expert technical knowledge affix within the confines of a small boat an electrical control device permitting the connection of various accessories to a typical 12 volt direct current power source.

### BACKGROUND

1. Field

Invention relates generally to the rigging of small boats to accommodate the operation and function of various electrical accessories such as bow/stern lights, bilge pumps, aerators, depth finders, fish locators, deck lights, spotlights, and other such devices as may from time to time require a low current 12 volt DC power supply. The invention may also be applied in other fields where a self-contained surface-mounted 12-volt DC electrical control device is desired.

2. Description of Prior Art

### References Cited

U.S. Pat. No. 3,269,210 Aug. 30, 1966 O. L. Steele, Jr., et al

U.S. Pat. No. 4,209,820 Jun. 24, 1980 Morton S. Rundel, Frank R. Keller, Peter M. Moritz, et al

U.S. Pat. No. 4,706,810 Nov. 17, 1987 Peter J. Petrelli, et al

U.S. Pat. No. 4,858,067 Aug. 15, 1989 Gary P. Rochelle, Charles R. Lile, et al

U.S. Pat. No. 5,662,505 Sep. 2, 1997 Charles Spriggs, et al

Most of the fleet of small boats extant in the United States and suitable for the application of this invention have been produced since the end of World War Two. There have been two major types of hull materials used to manufacture these boats—aluminum, and more recently, fiberglass. Within this fleet of small boats there are two further sub-categories; boats that are pre-rigged with electrical systems and accessories by the factory and those that are not so equipped. In the first case, many boats are fitted with consoles, decks, seats, hull liners, sub-decks, gear storage enclosures, and may be generally described as ski boats, cruisers, bass boats, and other similarly finished vessels that have as factory installed equipment electrical accessories and associated controls. Almost all of these boats have consoles, panels, and other such surfaces. Manufacturers use those features as a place to mount switches, circuit breakers, fuse holders, lights, gauges, and other electrical controls. The distinction here is that these boats use various surface areas of the vessel as locations for the electrical controls and typically utilize the space behind these surfaces and the control panels as the electrical enclosure. The second case invokes and involves that portion of the extant small boat fleet which was not factory equipped with electrical devices and/or controls. In many cases these boats are the smallest of the boats in general use and are typically described as Jon boats, fishing boats, aluminum boats, flat-bottomed boats, and by other names generally associated with the lowest levels of the boat sales market (“Jon Boats”).

There are many thousands of these Jon Boats now in private ownership as well as others within the supply chain between manufacturers, distributors, and dealers, Most of these Jon Boats have been or will be sold and delivered without any further additions or modifications in terms of electrical systems. There are large numbers of these boats which have been or will be fitted or rigged with lights, bilge pumps, depth finders, fish locators, deck lights, and other accessories in order to comply with the regulations of the various federal, state, and local authorities having jurisdiction over the operation of vessels in the various waters and otherwise to facilitate the needs and desires of the owners. In the case of many of these Jon Boats the rigging of electrical accessories has been left to the imagination and (too frequently) limited technical abilities of the owner.

There are many problems associated with rigging a boat for safe and proper operation. Not the least of these problems has been how to connect the various accessories to a power supply given the number of circuits required and the lack of suitable devices designed specifically for this purpose. Typically the process is completed to the point of installing all of the accessories and connecting circuit wires to a location near the battery. At the same time, it is frequently desirable to include some form of circuit protection to prevent damage to the accessories in the event of an electrical short or water soaking. The circuit protection function has been typically facilitated by the use of “in-line” fuse holders or circuit breakers. The prior art does not accommodate either of these functions conveniently, effectively, or with the highest levels of safety attainable, especially in view of the skill levels frequently employed in the installation process.

The only existing devices available for accomplishing the latter two tasks by means of a control panel consist of switch or combination switch/circuit protection panels which are limited as follows: 1) these devices are typically fabricated in such a manner as to require that they be mounted into a cut-out space in an existing console or other flat surface. In the typical Jon Boat this is not possible without compromising the structural integrity of the hull or of the floatation materials located behind the limited mounting surfaces which typically also serve as the combination bench seats/primary structural cross members, and 2) no provision is made in these devices for the negative or “ground” side of the individual circuits leaving the rigger with the problem of connecting multiple wires to a battery terminal not designed to accommodate that need. The only other existing devices designed for this purpose connect directly to the battery as an appendage to the terminal posts and said devices do not provide for switch or circuit protection functions. Neither device type lends itself to application in a Jon Boat due to the simple design methods employed in the construction of such boats and/or the limitations of the device itself with regard to location within the vessel. And, in the case of the battery terminal type device there is no provision for switching of individual devices.

### SUMMARY OF THE INVENTION

The invention is designed to circumvent the many problems associated with the rigging of small boats as described above. It provides a safe and efficient self-contained surface-mounted means of connecting a plurality of electrical boating accessories to a 12-volt direct current power source. The invention installs on any vertical or near vertical surface in minutes thereby saving time and greatly simplifying the task of connecting various accessories to the external power supply. Installation is accomplished in such a manner as to not disrupt the structural integrity of the vessel. The means of installation is by the use of screws, rivets, or other fasteners through the external mounting flanges provided for such fasteners. The essence of the invention is the provision, in the form of a self-contained surface-mounted control unit, of fuse-protected separately switched circuits which have only to be connected to the several accessories and the battery with the attached leads and cables in order to function.

In its component parts this invention comprises a weather resistant box enclosure having a port or opening through which the power cables and several circuit leads enter/exit the enclosure, a cover affixed to the enclosure with screws or other fasteners, and which cover serves as the mounting surface and control panel whereupon a plurality of switches and fuse holder assemblies are mounted, and the necessary wires, connectors, screws, tie wraps, gaskets, and other incidental parts required to connect the plurality of circuits required. The demonstrated enclosure is a readily available commercial enclosure. In this embodiment there are three fuse holders and three switches featuring a unique circuit set but said devices and circuits may vary from application to application and number of accessories to be controlled.

[The circuit set in this application is a part of the patent being claimed]

### BRIEF DESCRIPTION OF THE DRAWINGS

FIG. 1A—Is a sketch of a typical off-the-shelf enclosure—Front View

FIG. 1B—Is a sketch of a typical off-the-shelf enclosure—Side View

FIG. 2—Is a sketch of the circuit schematic

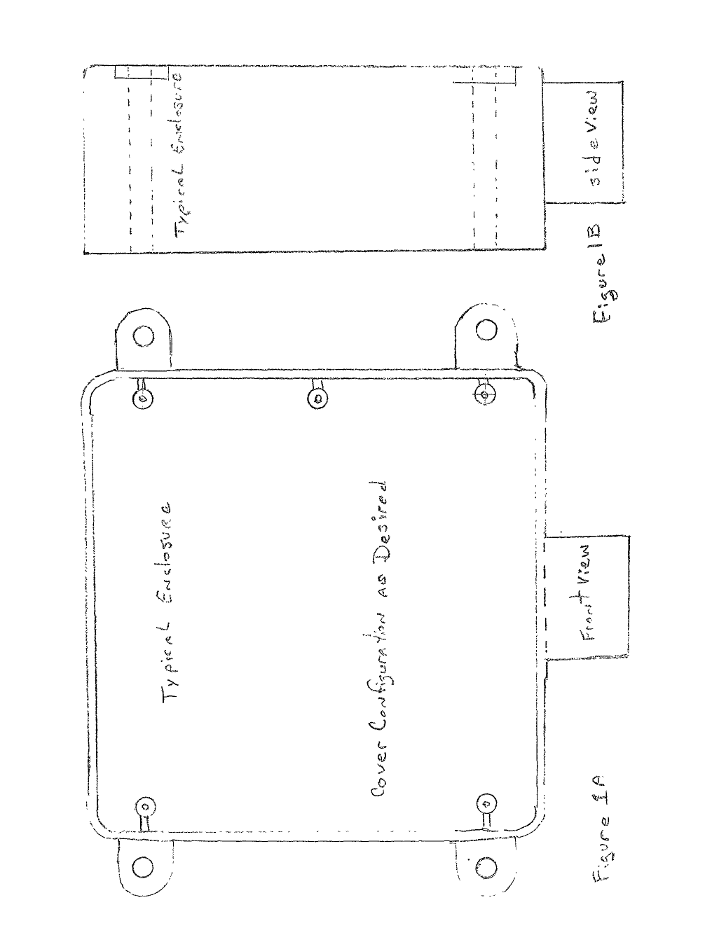

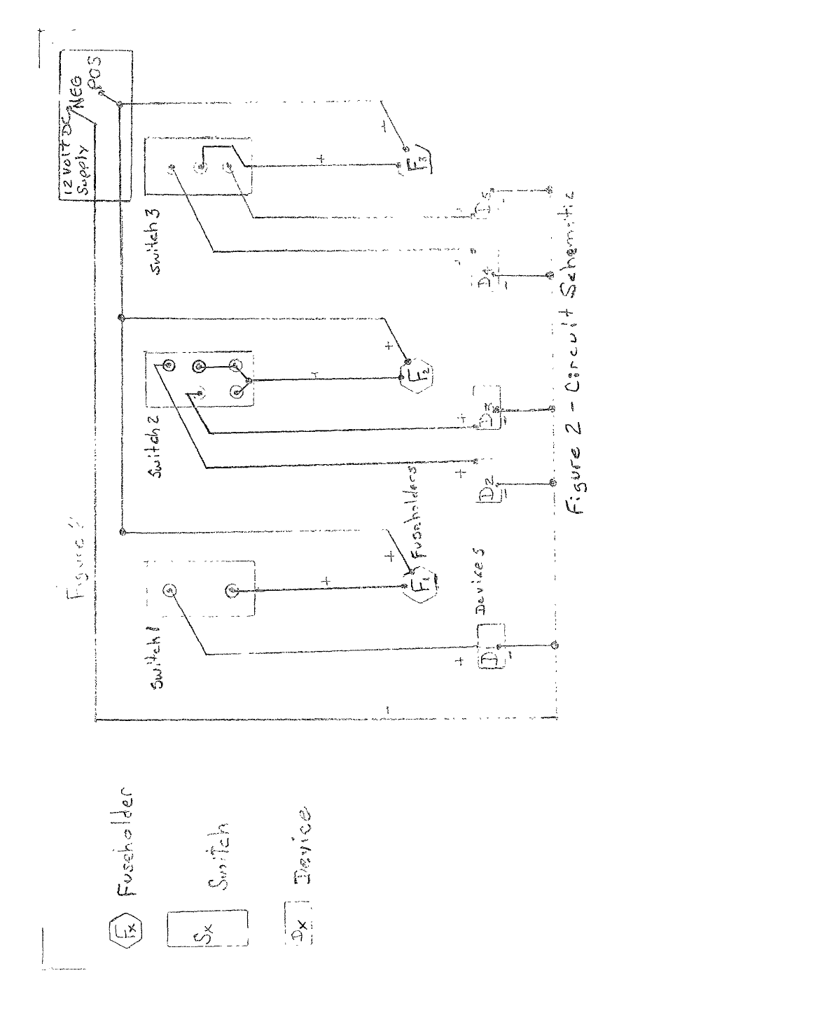

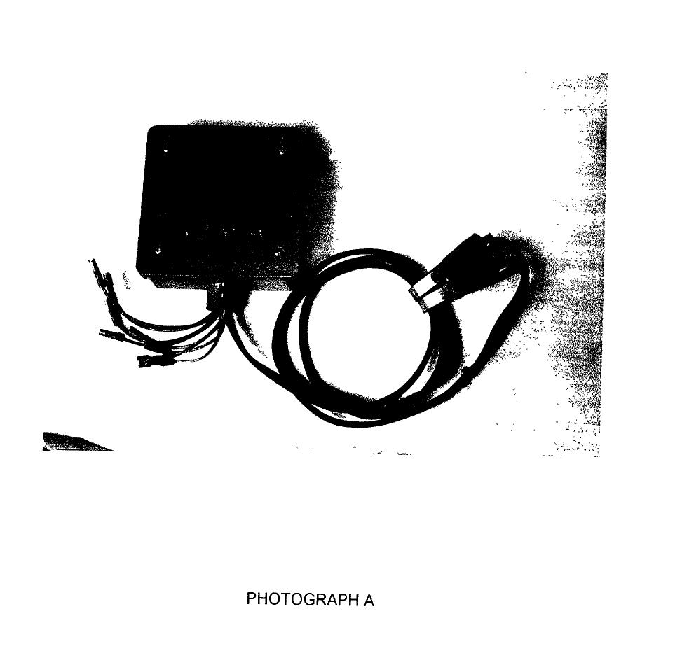

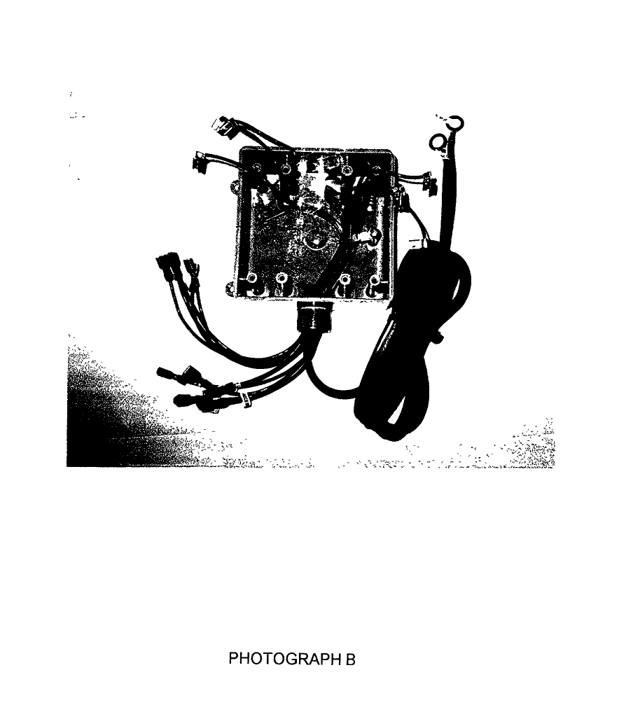

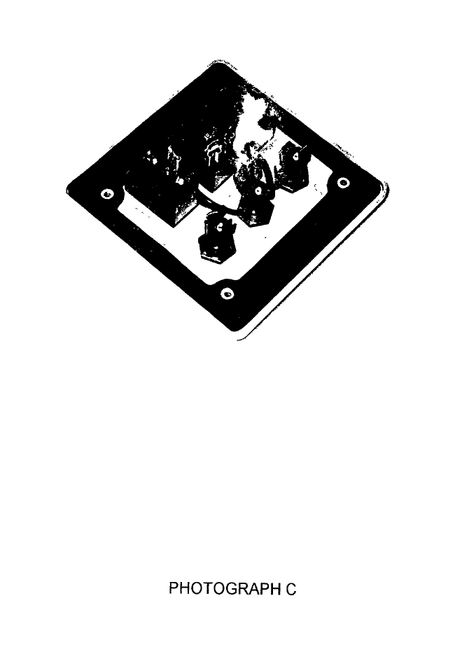

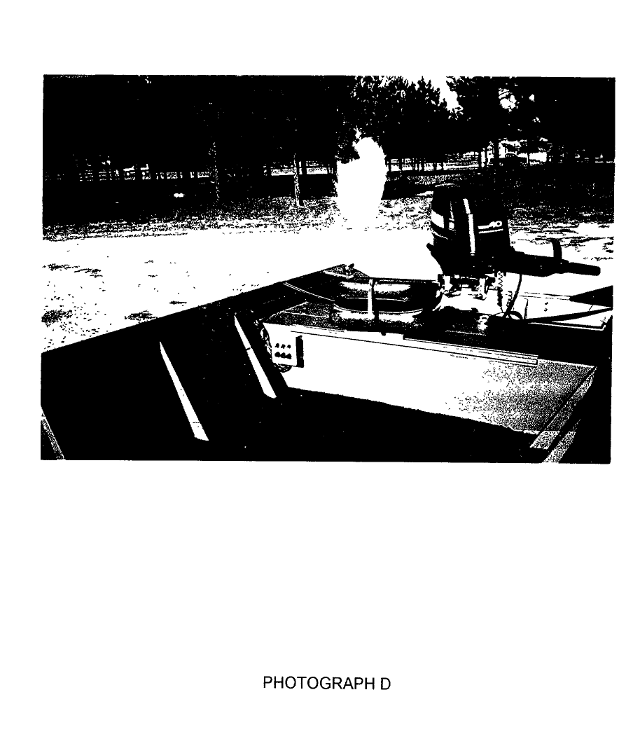

Photograph A—Depicts the invention ready to install

Photograph B—Shows the interior of the enclosure body with the circuit wiring in place and ready to be connected to Fuse Holders and Switches

Photograph C—Shows the reverse of the enclosure cover with Switches and Fuse Holders in place and ready to connect to the circuit wiring

Photograph D—Shows the invention installed on a Jon Boat

### DETAILED DESCRIPTION OF THE PREFERRED EMBODIMENT

The preferred embodiment of the invention comprises a weather-resistant surface-mounted off-the-shelf electrical enclosure with a plurality of switches and fuse holders installed on the enclosure cover itself. These switches and fuse holders are configured in such a manner as to allow the separate control of four individual circuits. Specifically, the first circuit as shown herein is the “Accessory” circuit, which is controlled by means of a weatherproof single-pole single-throw toggle switch that is itself fed through a fuse holder. This circuit may be used for any application which the operator desires but would typically be used for a depth finder, spotlight, cigar lighter, or other device. The second circuit is controlled by means of a weatherproof progressive three-position double-pole double-throw toggle switch that is designed to comply with US Coast Guard regulations regarding small boat lighting. Specifically the first “on” position completes the circuit to the “anchor”, “all round”, or “stern” light as it is variously named. The second “on” position completes the circuit to the “bow” light and at the same time maintains the “stern” light circuit in the “on” position for use while underway. The second circuit is likewise fed and protected by means of a fuse holder. The third circuit is controlled by means of a weatherproof single-pole double-throw three-position toggle switch having the center as the “off” position. This switch configuration allows then the alternate operation of circuits that in the preferred embodiment would be an aerator or live-well pump in the “up” position or a bilge pump in the “down” position. Since most such pumps operate in the 0.8 to 3.0 amps load range, the pairing of these two applications is more logical and allows use of a common fuse rating.

Referring to FIG. 3 and Photograph D the invention is depicted photographically and schematically installed on a Jon Boat. In the preferred embodiment the invention is installed on the seat wall of the vessel which installation leaves intact the safety floatation materials as typically installed by the manufacturers in the Jon Boats. The battery leads are connected to a 12 volt DC marine battery that may or may not also be employed as the power source for an independently controlled electric motor. At this point the invention may be connected to existing or newly installed circuits by simple means of the fully insulated spade connections provided for that purpose. In this respect the provision of ground connections for each circuit allows the installation process to be completed without further need to route additional wiring or to install common terminal blocks.

### FUNDAMENTAL DIFFERENCES BETWEEN THE INVENTION & PRIOR ART REFERENCED ABOVE

U.S. Pat. No. 3,269,210 Aug. 30, 1966 O. L. Steele, Jr., et al

1. Thrust and application of “210” is as part of vessels mechanical steering controls system permanently mounted to boat and having instrumentation incidentally installed in steering console.

2. “210” is not suitable for installation on a Jon Boat—the primary application of my invention.

3. My invention does not include any mechanical linkages to steering systems and contains no instrumentation.

4. “210” is not a closed self-contained surface-mounted unit, rather it requires cutting of openings in portions of the host vessel to accommodate installation and is attached through mechanical linkages to the engine or steering components of the host vessel.

U.S. Pat. No. 4,209,820 Jun. 24, 1980 Morton S. Rundel, Frank R. Keller, Peter M. Moritz, et al

1. Thrust and application of “820” is as an alternating current (“a/c”) control for fixed equipment, power doors, factory machinery, etc. “820” is designed to provide a low-voltage a/c relay control function typically employed to engage/disengage three-phase high voltage a/c operated industrial equipment in industrial applications.

2. Primary thrust of “820” appears to be the inter-changeability of snap-in components.

3. “820” is not designed for marine applications, is not weather-resistant or weatherproof, and does not feature circuit protection components.

U.S. Pat. No. 4,706,810 Nov. 17, 1987 Peter J. Petrilli, et al

1. Thrust and application of “810” is as removable instrument/radio shelter with the primary intention of securing the equipment during use and the ready removal of the invention together with all installed devices following each use primarily for security purposes.

2. “810” differs substantially from my invention in size, weight, complexity, materials, application, and facilitation on Jon Boats, and stated purpose.

U.S. Pat. No. 4,858,067 Aug. 15, 1989 Gary P. Rochelle, Charles R. Lile, et al

1. Thrust and application of “067” is as removable chassis system for affixing a/c controls to a spa-type fixture.

2. “067” is not applicable to marine vessels for the same purpose as my invention and in fact could prove hazardous as it is not designed as a weather-resistant enclosure. The enclosure differs substantially in that it comprises several metal sub-components and is not designed to be self-contained or surface-mounted.

U.S. Pat. No. 5,662,505 Sep. 2, 1997 Charles Spriggs, et al

1. Thrust and application of “505” appears to be a humorous submittal. The term “Rube Goldberg” seems to apply.

2. “505” control panel is not a weather-resistant self-contained surface-mounted component and, considered as a whole, the thrust of the invention is to the assembly of an electrically driven canoe, complete.

1. This invention is unique in being self-contained and surface mounted.

2. This invention is unique in that it provides for separate individual connections for the ground side of each circuit as an integral part of that device.

3. This invention is unique in that it requires, after mounting, only connection to the power supply and individual accessories/devices to be fully functional.

4. This invention is unique in the application of the electrical circuit demonstrated in the patent.
